(19) United States
(12) Patent Application Publication
(10) Pub. No.: US 2009/0222593 A1
(43) Pub. Date: Sep. 3, 2009

(54) Server device, method and program

(76) Inventors: Shinya Murai, Kanagawa-Ken (JP); Takuya Kawamura, Kanagawa-Ken (JP); Kotaro Ise, Saitama-Ken (JP); Keiichi Yamaguchi, Kanagawa-Ken (JP); Masataka Goto, Kanagawa-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/585,252

(22) PCT Filed: Mar. 28, 2006
(86) PCT No.: PCT/JP06/07010

§ 371 Date: Apr. 15, 2009

(30) Foreign Application Priority Data
Jun. 27, 2005 (JP) 2005-186108

(51) Int. Cl. G06F 3/00

(52) U.S. Cl. 710/12

(57) ABSTRACT

There is provided with a server device which outputs a result of computation processing to an output device, including: a communication unit configured to receive a connection request from an input device; an output device manager configured to store an identifier of the output device; and an connection controller configured to acquire output capability information of the output device, configured to acquire input capability information of the input device, configured to generate secret information which can be input to the input device and can be output by the output device, on the basis of the input capability information and the output capability information, configured to transmit the secret information to the output device, and configured to generate a result of computation processing based on input information received from the input device for transmitting to the output device in a case of receiving the secret information from the input device.

### CROSS-REFERENCE TO RELATED APPLICATIONS

This application is based upon and claims the benefit of priority from the prior Japanese Patent Applications No. 2005-186108 filed on Jun. 27, 2005, the entire contents of which are incorporated herein by reference.

### BACKGROUND OF THE INVENTION

1. Field of the Invention

The present invention relates to a server device, method and program which receives input information from an input device used by the user via a network and outputs a result of computation processing based on the input information to an output device used by the same user via the network.

2. Description of the Background

As for a technique of connecting an input-output device to a server device via a network and using computation capability of the server device, there is “Smart Display” of the Microsoft Corporation.

The Smart Display is a display apparatus having a wireless communication IF (Interface), simple computation processing capability, and an input function using a touch pad. The Smart Display is connected to a server PC (Personal Computer) via a network, and the Smart Display displays screen information of application which operates on the server PC. Furthermore, the Smart Display can utilize an application on the server PC by transmitting an input command for the application to the server PC.

If input-output devices other than the display apparatus and a touch pad are connected to the server device via the network and used, however, it is premised in the Smart Display that all inputs and outputs by devices, such as the mouse, other than the display apparatus are also conducted via the display apparatus. Therefore, the display apparatus needs to have an IF that can be connected to various input-output devices, resulting in a problem of a complicated display apparatus.

The problem of the display apparatus becoming complicated can be avoided by making it possible to connect various input-output devices to the server device directly via the network. In this case, however, it is necessary, at the time of use start of each of the input-output devices, for the server device to permit the use of the device after making sure that the device is an input-output device used by a legal user. In the case of the input-output device such as a display apparatus having a touch panel, it is possible to make sure that the user is a legal user by making the user input secret information such as a password. In the case of a device having a poor input function, such as a mouse, it is difficult to make the user input secret information to make sure that a legal user is using the device, resulting in a problem.

By the way, an example of a procedure for permitting to use an output device that is connected to a network and that is in the neighborhood, from another device that is connected to the network and that is at hand is proposed in, for example, JP-A-2004-102663.

### SUMMARY OF THE INVENTION

According to an aspect of the present invention, there is provided with a server device which outputs a result of computation processing to an output device, comprising: a communication unit configured to receive a connection request from an input device; an output device manager configured to store an identifier of the output device; and an connection controller configured to acquire output capability information of the output device, the output capability information indicating which kind of output the output device can do, configured to acquire input capability information of the input device, the input capability information indicating which kind of input the input device can do, configured to generate secret information which can be input to the input device and can be output by the output device, on the basis of the input capability information and the output capability information, configured to transmit the secret information to the output device, and configured to generate a result of computation processing based on input information received from the input device for transmitting to the output device indicated by the identifier stored in the output device manager in a case of receiving the secret information from the input device.

According to an aspect of the present invention, there is provided with a server device which generates a result of computation processing based on input information from an input device, comprising: a communication unit configured to receive a connection request from an output device; an input device manager configured to store an identifier of the input device; and an connection controller configured to acquire input capability information of the input device, the input capability information indicating which kind of input the input device can do, configured to acquire output capability information of the output device, the output capability information indicating which kind of output the output device can do, configured to generate secret information which can be input to the input device and can be output by the output device, on the basis of the input capability information and the output capability information, configured to transmit the secret information to the output device, and configured to output a result of computation processing based on input information received from the input device indicated by the identifier stored in the input device manager for transmitting to the output device in a case of receiving the secret information from the input device.

According to an aspect of the present invention, there is provided with a program executed in a server device which receives input information from an input device via a network, and outputs a result of computation processing based on the input information to an output device on the network, comprising: a program module for receiving a connection request from the input device; a program module for acquiring output capability information of the output device, the output capability information indicating which kind of output the output device can do; a program module for acquiring input capability information of the input device, the input capability information indicating which kind of input the input device can do; a program module for generating secret information which can be input to the input device and output by the output device, on the basis of the output capability information and the input capability information; a program module for transmitting the secret information to the output device; and a program module for generating a result of computation processing based on input information received from the input device for transmitting to the output device in a case of receiving the secret information from the input device.

### BRIEF DESCRIPTION OF THE DRAWINGS

FIG. 1 is a configuration diagram of a first embodiment;

FIG. 2 is a diagram showing an example of information stored in a permitted output device manager;

FIG. 3 is a diagram showing a message flow in the first embodiment;

FIG. 4 is a flow chart showing a flow of processing conducted by a server device;

FIG. 5 is a diagram showing an example of a message format;

FIG. 6A to 6E is a diagram showing examples of various messages;

FIG. 7 is a flow chart showing a flow of processing conducted by an input device;

FIG. 8 is a flow chart showing a flow of processing conducted by an output device;

FIG. 9A to 9C is a diagram showing an example of a method for generating secret information;

FIG. 10 is a diagram showing an example of secret information displayed on an output device;

FIG. 11 is a diagram showing an example of secret information displayed on an output device;

FIG. 12 is a configuration diagram of a second embodiment;

FIG. 13 is a diagram showing an example of information stored in a permitted input device manager;

FIG. 14 is a diagram showing a message flow in the second embodiment;

FIG. 15 is a configuration diagram of a third embodiment; and

FIG. 16 is a diagram showing an example of information stored in a permitted output device manager.

### DETAILED DESCRIPTION OF THE INVENTION

### First Embodiment

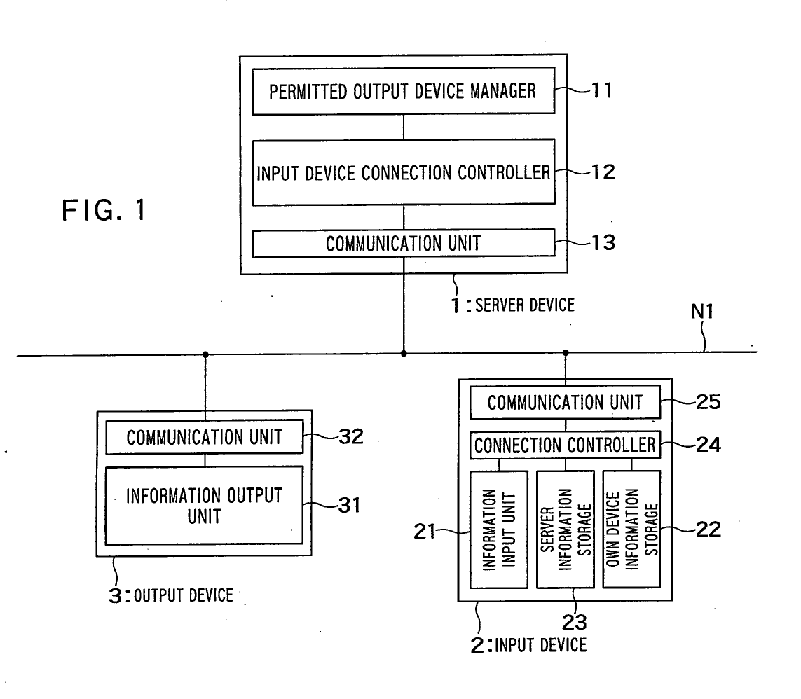

FIG. 1 shows an example of configurations of a server device 1, an input device 2 and an output device 3 in the present embodiment.

The input device 2 includes an information input unit 21 which accepts an input from a user.

The input device 2 includes an own device information storage 22 which stores own device information including an identifier of the own device and capability information of the own device. Here, the capability information means more detailed capability information such as a classification of the input device, such as a mouse, a keyboard or a camera, a classification of a mouse (such as an optical mouse), and a resolution of a camera.

The input device 2 includes a server information storage 23 which stores information containing an identifier of a server device to be connected to the input device. The identifier of the server device is an identifier needed as destination information, such as an IP address of the server device, when conducting communication with the server device via a network.

The input device 2 includes a connection controller 24 which establishes connection with the server device on the basis of information input to the information input unit 21, the own device information stored in the own device information storage 22, and the information stored in the server information storage 23.

The input device 2 includes a communication unit 25 which exchanges information with the server device connected via a network N1.

As an example of the input device 2, a mouse, a keyboard, a touch panel, a tablet, a microphone, a camera or the like having the above-described components is conceivable.

The output device 3 includes an information output unit 31 which presents information to the user.

The output device 3 includes a communication unit 32 which exchanges information with the server device connected thereto via the network N1.

As an example of the output device 3, a display apparatus, a printer, a projector or a speaker having the above-described components is conceivable.

By the way, the input device need not be a device having only the input function, but may have an output function. For example, a projector may have the camera function as well.

The output device need not be a device having only the output function, but may have an input function. For example, a display apparatus may have a touch panel as well.

The server device 1 receives input information from the input device 2 via the network N1, conducts computation on the basis of the received input information, and outputs a result of the computation processing to the output device 3 connected to the network N1. For example, upon receiving an instruction for an application program operating on the server device 1 from a keyboard, the server device 1 executes predetermined processing, and transmits screen data reflecting a result of the execution to a display apparatus.

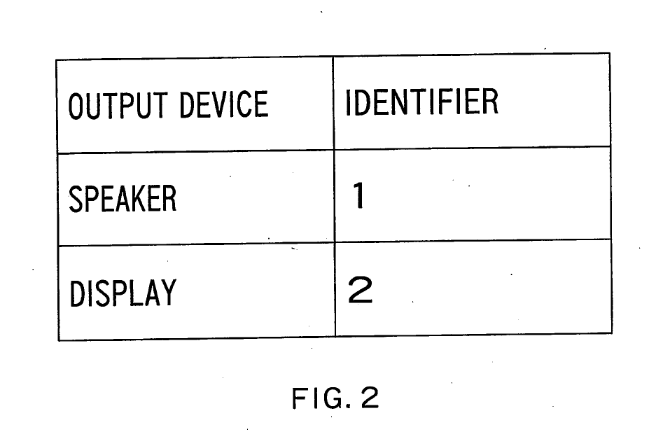

The server device 1 includes a permitted output device manager 11 which stores information containing identifiers of output devices already permitted to be connected. An example of information stored by the permitted output device manager 11 is shown in FIG. 2.

The server device 1 includes an input device connection controller 12 which controls connection with the input device.

The server device 1 includes a communication unit 13 which exchanges information with the output device and the input device connected thereto via the network N1.

Here, it is supposed that the application program operates on the server device 1. However, it is not always necessary. The server device 1 may transfer the received instruction command to a different apparatus on which the application program is actually operating, receive screen data to which a result of execution of an instruction has been reflected, from the different apparatus, and transfer the received screen data to the display apparatus.

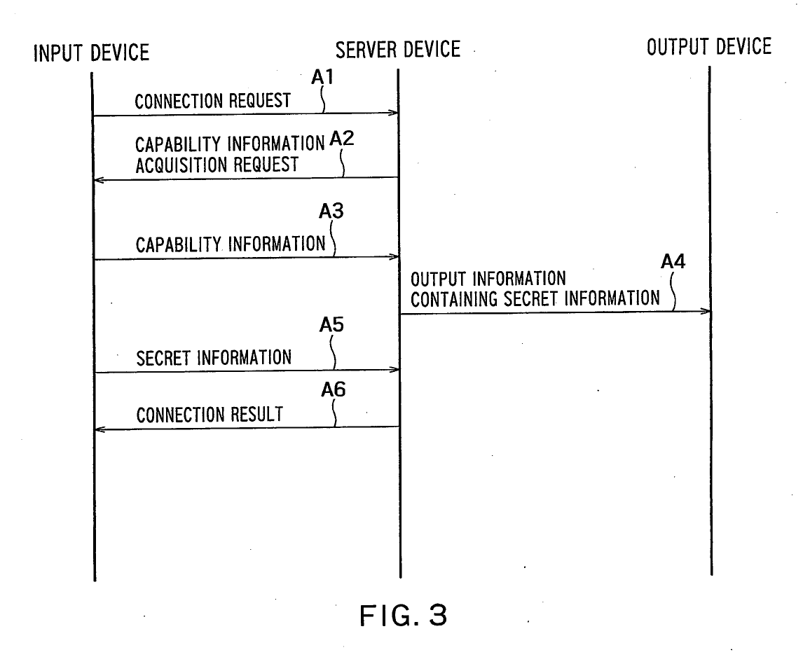

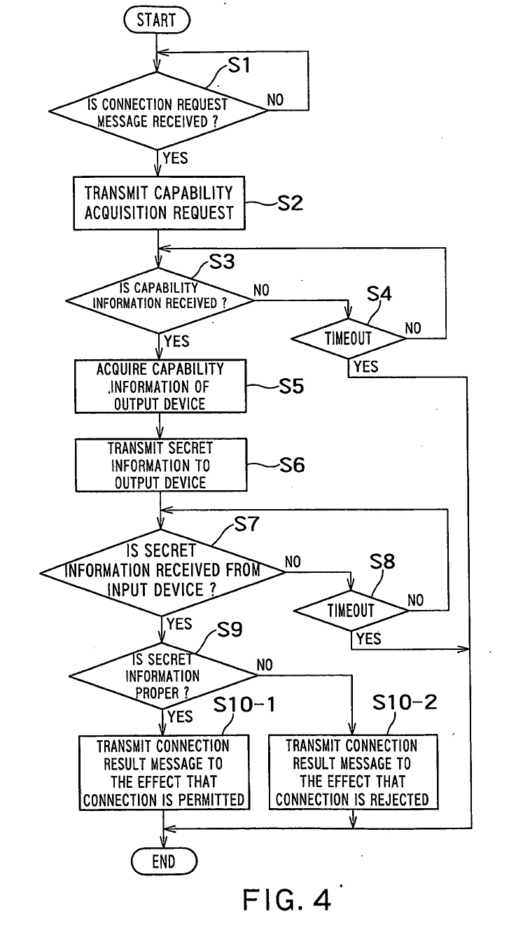

Hereafter, operation of the server device 1 conducted when connecting the input device 2 to the server device 1 will be described with reference to FIG. 3 and FIG. 4. However, it is supposed that connection between the output device 3 and the server device 1 has already been completed.

FIG. 3 shows a message flow between the server device 1, and the input device 2 and the output device 3. FIG. 4 is a flow chart showing a flow of processing conducted by the server device 1.

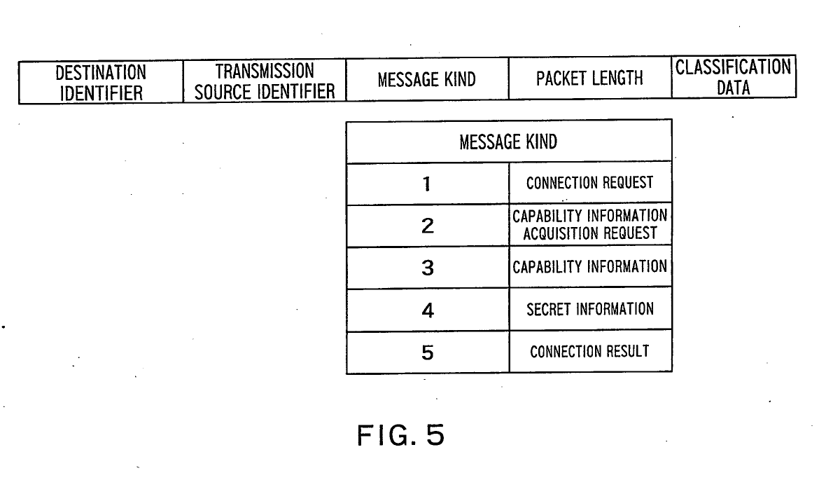

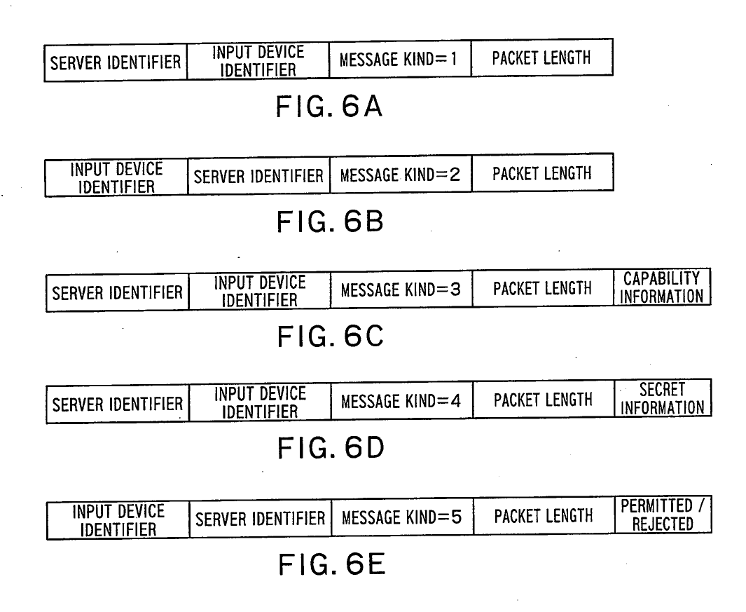

The server device 1 determines whether a connection request message has been received from the input device 2 (S1). If a connection request message has not been received (No at S1), reception of the connection request message is waited for. An example of a message format used in the present embodiment is shown in FIG. 5. FIG. 6A shows an example of the connection request message.

Upon receiving a connection request message (yes at S1, A1), the input device connection controller 12 in the server device 1 transmits a capability information acquisition request message to the input device 1 by using an identifier of the input device 2 contained in the connection request message (S2, A2). FIG. 6B shows an example of the capability information acquisition request message.

The server device 1 determines whether a capability information message has been received from the input device 2 (S3). FIG. 6C shows an example of the capability information message. If a capability information message has not been received (no at S3), the server device 1 determines whether timeout has occurred (S4). If timeout has occurred (yes at S4), the server device 1 terminates the processing. If timeout has not occurred (no at S4), the server device 1 waits for reception of the capability information message. Here, capability information of the input device is, for example, the classification of the input device (such as the mouse, keyboard or camera) and more detailed information (such as whether the device is an optical mouse, or the resolution of the camera). Here, the server device 1 acquires the capability information after receiving the connection request from the input device 2; however, if capability information is contained in the connection request message itself, this procedure can be omitted.

If the server device 1 receives a capability information message from the input device (yes at S3, A3), the input device connection controller 12 in the server device 1 acquires capability information of the output device 3 on the basis of an identifier stored in the permitted output device manager 11 (S5). Here, capability information of the output device is, for example, a classification of the output device (such as a display apparatus or a speaker) and more detailed information (such as the resolution of the display apparatus). The capability information of the output device may be stored in association in the permitted output device manager 11, and acquired from the permitted output device manager 11. After a connection request has been generated, the capability information may be acquired from the output device by requesting the output device to transmit the capability information.

Subsequently, the input device connection controller 12 in the server device 1 generates secret information which can be easily input to the input device 2 requesting connection and which can be output in the output device 3 permitted to be connected, on the basis of the capability information of the input device 2 and the capability information of the output device 3, and transmits output information containing generated secret information to the output device 3 (S6, A4). If there are a plurality of output devices capable of outputting the generated secret information, output information containing the secret information may be transmitted to one of output devices or output information containing the secret information may be transmitted to all output devices. Furthermore, also in the case where output devices of a plurality of kinds are connected and separate secret information piece can be generate every output device, output information containing secret information may be transmitted to one of the output devices or output information pieces respectively containing secret information pieces may be transmitted respectively to output devices. By the way, it is desirable to alter the secret information to be generated every connection request.

Subsequently, the server device 1 determines whether a secret information message containing secret information input to the input device by a user has been received from the input device 2 (S7). FIG. 6D shows an example of the secret information message. If a secret information message has not been received (no at S7), the server device 1 determines whether timeout has occurred (S8). If timeout has occurred (yes at S8), the server device 1 terminates processing. If timeout has not occurred (no at S8), the server device 1 waits for reception of a secret information message.

Upon receiving a secret information message (yes at S7, A5), the server device 1 determines whether the received secret information is the same as the previously generated secret information (whether the received secret information is proper) (S9). If it is the same (yes at S9), the server device 1 transmits a connection result message containing information that represents that the connection is permitted, to the input device 2 (S10-1, A6). If it is different, the server device 1 transmits a connection result message containing information that represents that the connection is rejected, to the input device 2 (S10-2). FIG. 6E shows an example of the connection result message.

If the connection result message containing information that represents that the connection is permitted is transmitted to the input device 2, thereafter the server device 1 conducts computation processing by using input information input from the input device 2, and outputs a result of the computation processing to the output device 2. If different secret information is transmitted to each of a plurality of output devices at the step S6, the server device 1 outputs the result of the computation processing to an output device to which the same secret information as secret information received from the input device 2 is output. If the same secret information is transmitted to a plurality of output devices, the server device 1 outputs the result of computation processing to all of the output devices, an output device specified by the user, an output device having high priority, or an output device determined at random.

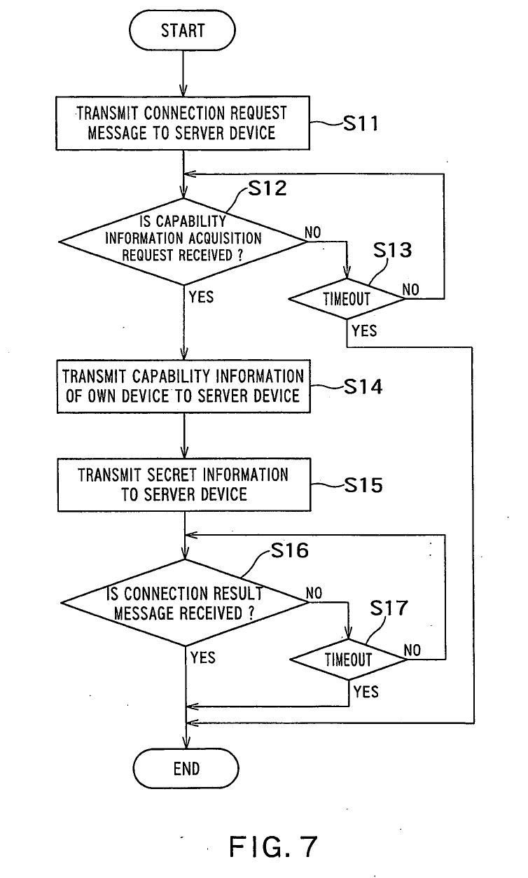

FIG. 7 is a flow chart showing a flow of processing conducted by the input device.

The connection controller 24 in the input device 2 transmits a connection request message inclusive of an identifier of the own device stored in the own device information storage 22 to the server device 1 by using an identifier of the server device stored in the server information storage 23 (S11, A1).

The input device 2 determines whether a capability information acquisition request message is received from the server device 1 (S12). Unless received (no at S12), the input device 2 determines whether timeout has occurred (S13). If timeout has occurred (yes at S13), the input device 2 terminates the processing. Unless timeout has occurred (no at S13), the input device 2 waits for reception of a capability information acquisition request message.

Upon receiving a capability information acquisition request message from the server device 1 (yes at S12, A2), the input device 2 returns capability information of the own device (S14, A3).

The user of the input device 2 inputs secret information output to the output device 3, by using the information input unit 21 in the input device 2. The input device 2 transmits a secret information message containing secret information input by the user, to the server device 1 (S15, A5). If the secret information is based on a plurality of inputs, the input device may transmit partial secret information to the server device 1 each time the partial secret information is input by the user. In this case, the server device 1 may send information representing an input situation to the output device 3 and present it to the user so as to make it possible for the user to ascertain the input situation of the secret information.

The input device 2 determines whether a connection result message is received from the server device 1 (S16). Unless a connection result message is received (no at S16), the input device 2 determines whether timeout has occurred (S17). If timeout has occurred (yes at S17), the input device 2 terminates the processing. If timeout has not occurred (no at S17), the input device 2 waits for reception of a connection result message.

If a connection result message has been received from the server device 1 (yes at S16), the input device 2 ascertains contents of the connection result message. If the connection result message contains information to the effect that the connection is permitted, i.e., the connection is permitted by the server device 1, the user inputs information from the input device 2, and causes the server device 1 to conduct processing based on the input information. The server device 1 presents a result of the processing on the output device 2. If the connection result message contains information to the effect that the connection is rejected, then the input device terminates processing, or returns to the step S11 and starts the procedure for connection to the server device 1 again.

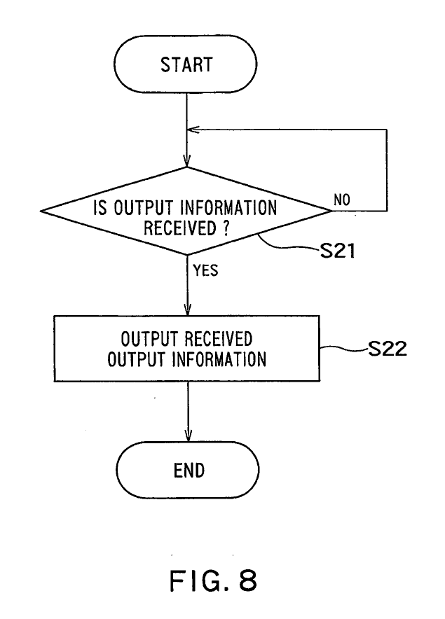

FIG. 8 is a flow chart showing a flow of processing conducted by the output device.

The output device 3 determines whether output information (such as secret information) is received (S21). If output information is received (yes at S21), the output device 3 outputs the received output information (S22). If output information is not received (no at S21), the output device 3 waits for output information sent from the server device 1.

How the server device generates the secret information on the basis of the capability information of the input device and the capability information of the output device will now be described in detail.

First, it is now supposed that the input device is a mouse and the output device is a display apparatus.

On the basis of the information to the effect that the input device is a mouse, the server device can understand that information of a movement quantity can be acquired when the mouse is moved and the user can input button-depressing-events of several kinds and releasing-events in the depressed state. Furthermore, the server device can understand that image information can be displayed on the display apparatus. On the basis of these results, the server device generates image information indicating operation instructions that can be input using the mouse as secret information, generates display image information containing the image information, and transmits the generated display image information to the display apparatus.

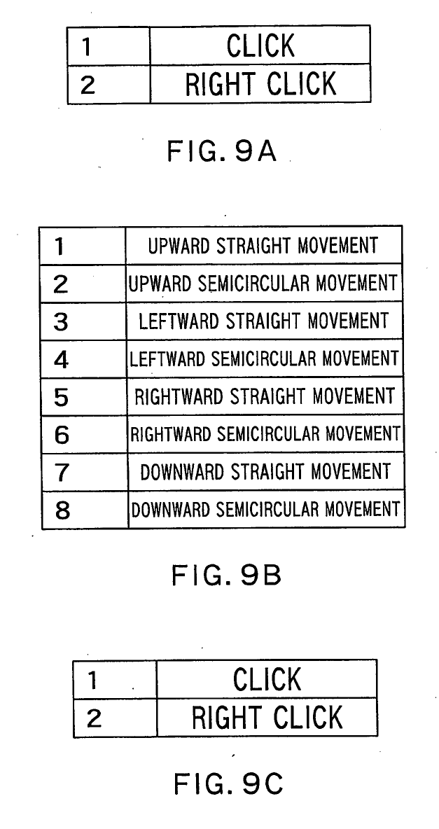

Hereafter, a concrete generation example of the secret information will be described. As shown in FIG. 9A to 9C, a table showing candidates for starting-button-operation, a table showing candidates for moving-operation, and a table showing candidates for completing-button-operation are prepared. One item is selected at random from each table, and secret information is generated using the three selected items. This is an example. For example, variations such as a straight movement to the upper right and an upward semicircle movement may be added as the candidates for the moving-operation. Secret information may be generated by combining a plurality of button operations and a plurality of moving-operations.

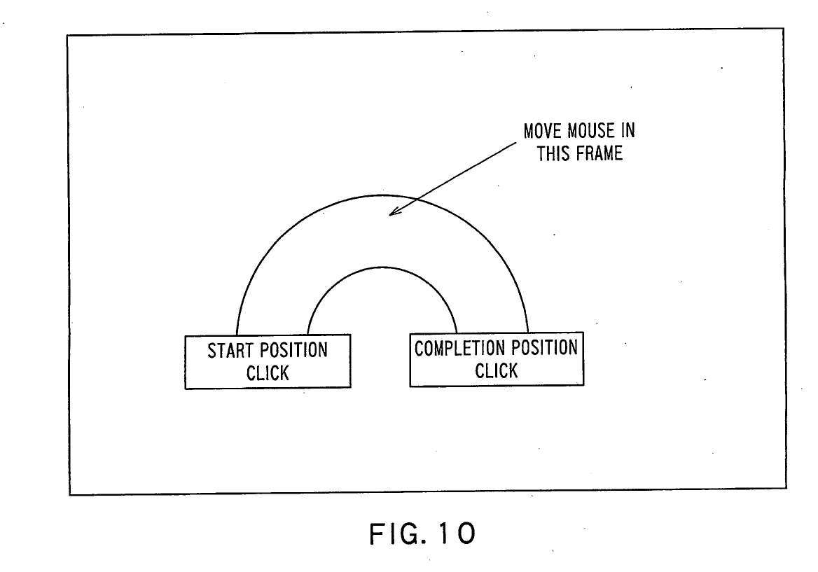

FIG. 10 shows an example of secret information generated by the server device in the case where the input device which has issued the connection request is a mouse and the output device already permitted to be connected is a display apparatus.

This example shows secret information generated in the case where click, upward semicircular movement and click are selected respectively as the starting-button-operation, the moving-operation, and the completing-button-operation in the tables shown in FIG. 9A-9C. In other words, this secret information orders the user to click in a start position by using the mouse, move a cursor in a frame displayed on the display apparatus, and click in a completion position. By using such an operation order, it becomes possible to easily input secret information even with the mouse. In the case of this example, the secret information includes a plurality of inputs using the mouse. It is supposed that each time the user gives an input, the mouse transmits a part of the secret information to the server device and the server device sends information representing the input situation to the output device and presents the information to the user. For example, while the mouse cursor is being moved, its movement situation is displayed on the display apparatus.

Hereafter, an example of secret information generation in the case where the input device is an optical mouse and the output device is a display apparatus will be described.

On the basis of information that the input device is the optical mouse, the server device can understand that a movement quantity of the mouse can be generated on the basis of a temporal change of image information input to an optical sensor in the optical mouse. Furthermore, the server device can understand that the image information can be displayed on the display apparatus. On the basis of these results, the server device generates image information such that an image input to the optical sensor in a fixed position changes with time, generates display image information containing the image information, and transmits the generated display image information to the display apparatus.

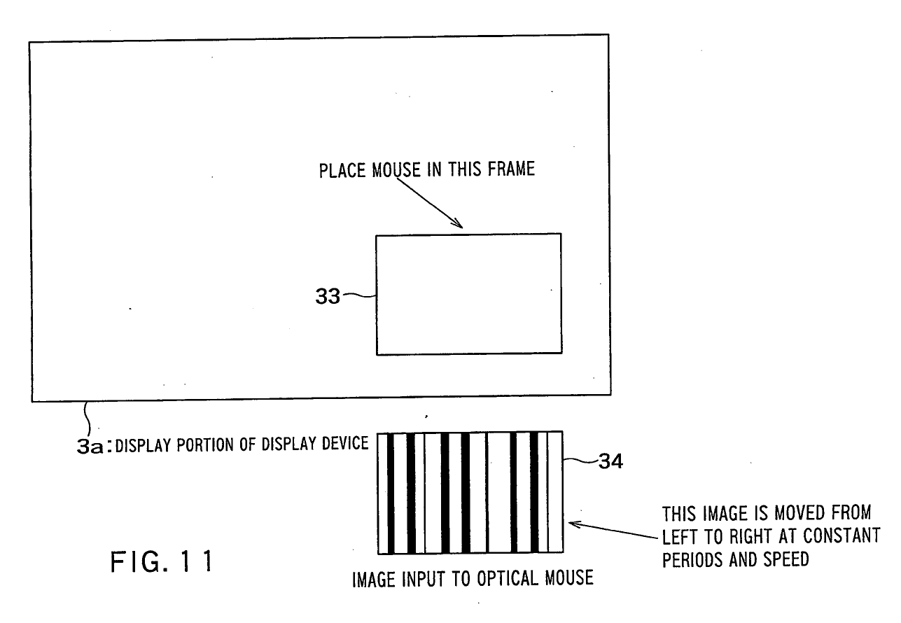

FIG. 11 shows an example of secret information transmitted to the display apparatus by the server device in the case where the input device that has issued a connection request is an optical mouse and the output device already permitted to be connected is a display apparatus.

Secret information 34 is an image that changes at constant periods and speed. This image is displayed in a secret information display position 33 on a display portion 3a of the display apparatus. It becomes possible to input the secret information 34 displayed in the secret information display position 33 to the optical mouse by holding up the optical mouse over the secret information display position 33. Even if a mouse is used therefore, it becomes possible to input the secret information easily.

Besides, in the case where the input device that has issued a connection request is a keyboard and the output device already permitted to be connected is a display apparatus, it becomes possible to input secret information easily even with only the keyboard, by presenting characters that can be input using the keyboard on the display apparatus as the secret information.

In the case where the input device that has issued a connection request is a camera and the output device already permitted to be connected is a display apparatus, it becomes possible to input secret information easily even with the camera, by displaying image information that can be input from the camera on the display apparatus as the secret information.

According to the present embodiment, it is possible to connect an input device to the server device using a simple procedure by presenting secret information that can be input to the input device to be connected from now on, on the output device already permitted to be connected, as heretofore described.

In other words, the possibility that a user other than the user using the output device can detect the output of the output device is low. Furthermore, even if a different user can detect secret information by, for example, stealing a glance at it, the different user cannot connect a different input device unless the different user inputs secret information generated for the different input device. Therefore, the different user cannot connect the different input device by using the secret information at which the different user stole a glance. Accordingly, it is possible to connect an input device to the server device according to a simple procedure while preventing an input device of another user from being falsely connected.

### Second Embodiment

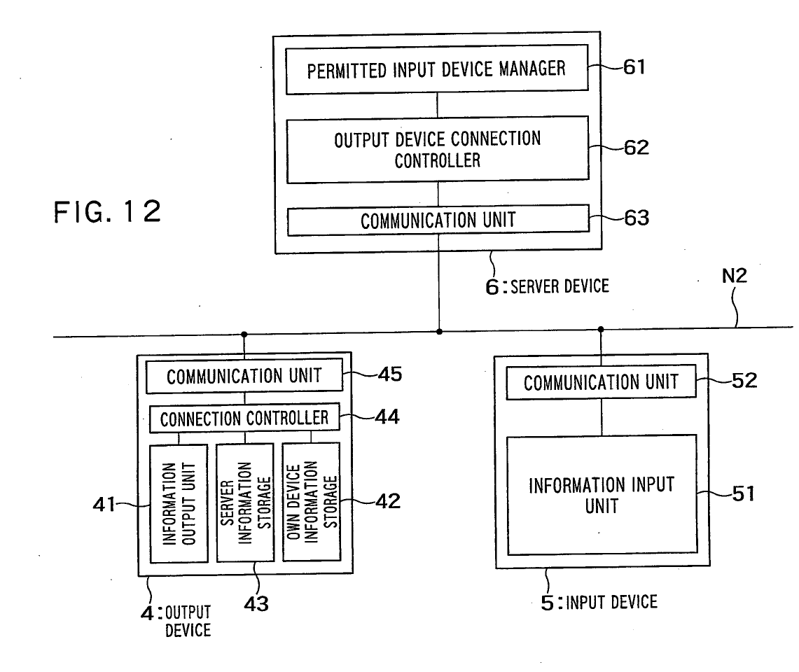

FIG. 12 shows an example of configurations of a server device 6, an input device 5 and an output device 4 in the present embodiment.

The output device 4 includes an information output unit 41 which presents information to a user.

The output device 4 includes an own device information storage 42 which stores own device information including an identifier of the own device and capability information of the own device.

The output device 4 includes a server information storage 43 which stores information containing an identifier of a server device to be connected to the output device. The identifier of the server device is an identifier needed as destination information, such as an IP address of the server device, when conducting communication with the server device via a network N2.

The output device 4 includes a connection controller 44 which establishes connection with the server device on the basis of information output to the information output unit 41, the own device information stored in the own device information storage 42, and the information stored in the server information storage 43.

The output device 4 includes a communication unit 45 which exchanges information with the server device connected via a network N2.

As an example of the output device 4, a display apparatus, a printer, a projector or a speaker is conceivable in the same way as the first embodiment.

The input device 5 includes an information input unit 51 which accepts information from the user.

The input device 5 includes a communication unit 52 which exchanges information with the server device connected thereto via the network N2.

As an example of the input device 5, a mouse, a keyboard, a touch panel, a tablet, a microphone, a camera or the like is conceivable in the same way as the first embodiment.

By the way, the input device need not be a device having only the input function, but may have an output function. For example, a projector may have the camera function as well.

The output device need not be a device having only the output function, but may have an input function. For example, a display apparatus may have a touch panel as well.

The server device 6 receives input information from the input device via the network N2, conducts computation on the basis of the received input information, and outputs a result of the computation processing to the output device 4 connected to the network N2. For example, upon receiving an instruction for an application program operating on the server device from a keyboard, the server device 6 executes predetermined processing, and transmits screen data reflecting a result of the execution to a display apparatus.

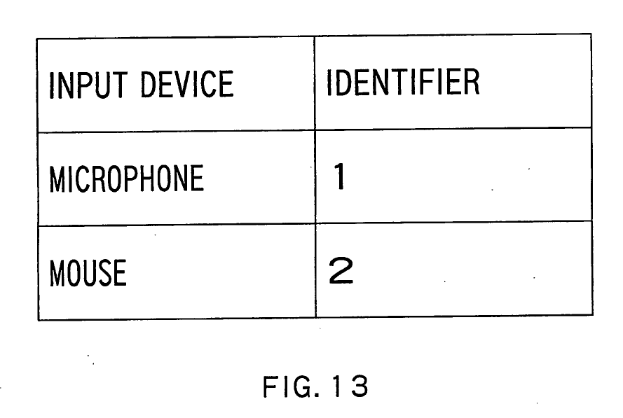

The server device 6 includes a permitted input device manager 61 which stores information containing identifiers of input devices already permitted to be connected. An example of information stored by the permitted input device manager 61 is shown in FIG. 13.

The server device 6 includes an output device connection controller 62 which controls connection to the output device.

The server device 6 includes a communication unit 63 which exchanges information with the output device and the input device connected thereto via the network N2.

Here, it is supposed that the application program operates on the server device 6. However, it is not always necessary. The server device 6 may transfer the received instruction command to a different apparatus on which the application program is actually operating, receive screen data to which a result of execution of an instruction has been reflected, from the different apparatus, and transfer the received screen data to the display apparatus.

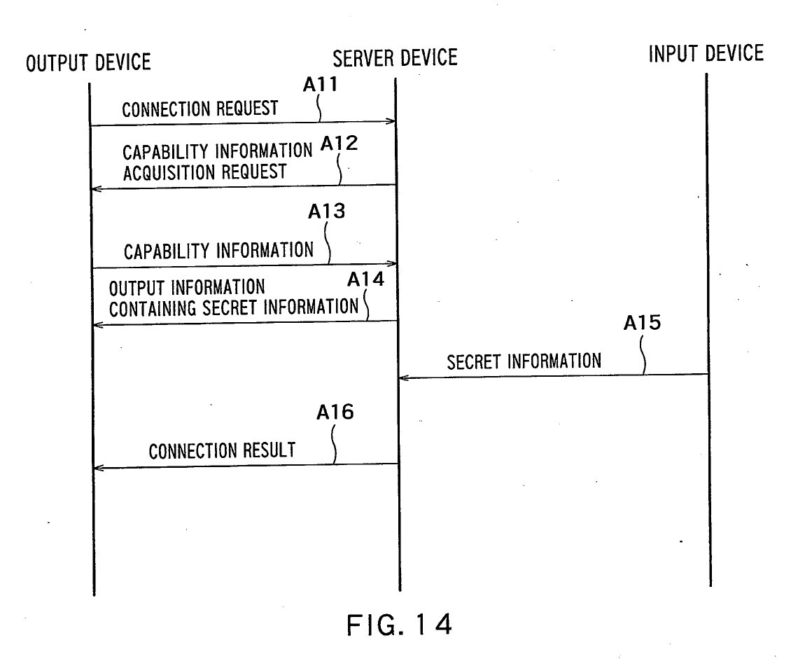

Hereafter, operation of the server device 6 conducted when connecting the output device 4 to the server device 6 will be described with reference to FIG. 14. However, it is supposed that connection between the input device 5 and the server device 6 has already been completed.

FIG. 14 shows a message flow between the server device 6, and the input device 5 and the output device 4.

The connection controller 44 in the output device 4 transmits a connection request message inclusive of an identifier of the own device stored in the own device information storage 42 to the server device 6 by using an identifier of the server device stored in the server information storage 43 (A11).

Upon receiving a connection request message, the output device connection controller 62 in the server device 6 transmits a capability information acquisition request message to the output device 4 by using an identifier of the output device 4 contained in the connection request message (A12).

Upon receiving the capability information acquisition request message (A13), the output device 4 returns capability information of the own device (A13). Capability information of the output device is, for example, the classification of the output device (such as the display apparatus or the speaker) and more detailed information (such as the resolution of the display apparatus).

Here, the server device 6 acquires the capability information after receiving the connection request; however, if capability information is contained in the connection request message itself, this procedure can be omitted.

Subsequently, the output device connection controller 62 in the server device 6 acquires capability information of the input device 5 on the basis of an identifier stored in the permitted input device manager 61. Here, capability information of the input device is, for example, a classification of the input device (such as a mouse, a keyboard or a camera) and more detailed information (such as whether the device is an optical mouse, or the resolution of the camera). Here, the capability information of the input device may be stored in association in the permitted input device manager 61, and acquired from the permitted input device manager 61. After a connection request has been generated, the capability information may be acquired from the input device by requesting the input device to transmit the capability information.

Subsequently, the output device connection controller 62 in the server device 6 generates secret information which can be easily input to the input device 5 already permitted to be connected, on the basis of the capability information of the output device 4 and the capability information of the input device 5. The secret information can be generated using the same method in the first embodiment. The server device 6 transmits output information containing the generated secret information to the output device 4. In the case where input devices of a plurality of kinds are connected and separate secret information can be input from each of the input devices, output information containing secret information that can be input from one of input devices may be transmitted to the output device, or output information containing a plurality of pieces of secret information that can be input respectively from the input devices may be transmitted to the output device. By the way, it is desirable to alter the secret information to be generated every connection request.

The user of the input device 5 inputs secret information output to the output device 4, by using the information input unit 51 in the input device 5.

Subsequently, the input device 5 transmits a secret information message containing secret information input by the user, to the server device 6 (A15).

Upon receiving a secret information message, the server device 6 determines whether the received secret information is the same as the previously generated secret information. If it is the same, the server device 6 transmits a connection result message containing information that represents that the connection is permitted, to the output device 4. If it is different, the server device 6 transmits a connection result message containing information that represents that the connection is rejected, to the output device 4 (A16).

If the secret information is based on a plurality of inputs, the input device may transmit partial secret information to the server device each time the partial secret information is input by the user. In this case, the server device 6 may send information representing an input situation to the output device and present it to the user so as to make it possible for the user to ascertain the input situation of the secret information.

According to the present embodiment, it is possible to connect an output device to the server device using a simple procedure by presenting secret information that can be input to the input device already permitted to be connected, on an output device to be connected from now on, as heretofore described. At this time, the possibility that a user other than the user using the input device can input secret information from the input device is low. Therefore, it is also possible to prevent an output device of another user from being falsely connected.

### Third Embodiment

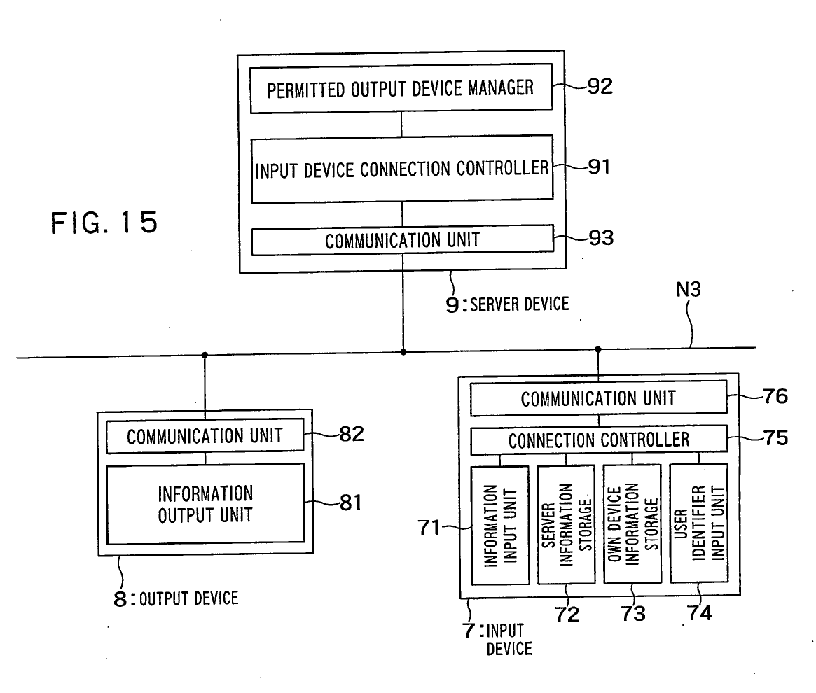

FIG. 15 shows an example of configurations of a server device 9, an input device 7 and an output device 8 in the present embodiment.

The present embodiment differs from the first embodiment in that a plurality of users can use a server device independently and simultaneously. In other words, in response to an input instruction from a certain user A, its computation result is output to an output device used by the same user A. In response to an input instruction from a different user B simultaneously requested, computation is conducted independently of the computation for the user A and a computation result is output to an output device used by the same user B.

The input device 7 includes an information input unit 71, a server information storage 72, an own device information storage 73, a user identifier input unit 74, a connection controller 75, and a communication unit 76. The user identifier input unit 74 inputs a user identifier. Except that the user identifier input unit 74 is present, the configuration of the input device is the same as that in the first embodiment. As an example of the user identifier input unit 74, a fingerprint scanning function, a changeover switch which can select a user identifier, or the like is conceivable.

The output device 8 includes an information output unit 81 and a communication unit 82. The configuration of the output device 8 is the same as that in the first embodiment.

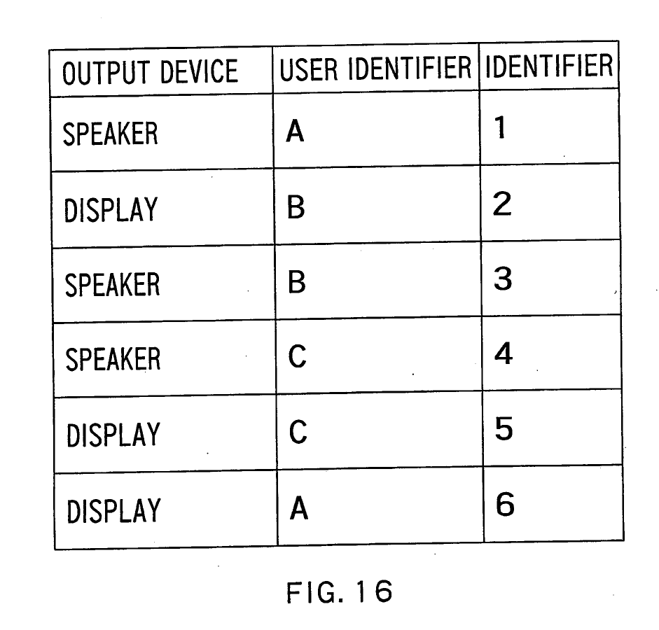

The server device 9 includes an input device connection controller 91, a permitted output device manager 92, and a communication unit 93. The configuration of the server device 9 is the same as that in the first embodiment except that a configuration of the permitted output device manager 92 is different from that in the first embodiment. The permitted output device manager 92 stores identifiers of users who can use output devices in addition to identifiers of the output devices. An example of information stored by the permitted output device manager 92 is shown in FIG. 16.

The connection controller 75 in the input device 7 transmits a connection request message inclusive of an identifier of the own device stored in the own device information storage 73 and a user identifier input to the user identifier input unit 74 to the server device 9 by using an identifier of the server device stored in the server information storage 72.

Upon receiving a connection request message from the input device 7, the input device connection controller 91 in the server device 9 acquires capability information of the input device 7. This procedure is the same as that in the first embodiment.

Subsequently, the input device connection controller 91 acquires capability information of an output device among the output devices stored in the permitted output device manager 92, which has a user identifier that coincides with a user identifier contained in the connection request.

The ensuing procedure is the same as that in the first embodiment.

According to the procedure heretofore described, it is possible to connect an input device to the server device using a simple procedure while preventing an input device of another user from being falsely connected, even if a plurality of users can utilize the server device independently and simultaneously. The present embodiment has been described on the basis of the first embodiment. However, the present embodiment can be applied to the second embodiment as well.

1. A server device which outputs a result of computation processing to an output device, comprising:
a communication unit configured to receive a connection request from an input device;
an output device manager configured to store an identifier of the output device; and
an connection controller
configured to acquire output capability information of the output device, the output capability information indicating which kind of output the output device can do,
configured to acquire input capability information of the input device, the input capability information indicating which kind of input the input device can do,
configured to generate secret information which can be input to the input device and can be output by the output device, on the basis of the input capability information and the output capability information,
configured to transmit the secret information to the output device, and
configured to generate a result of computation processing based on input information received from the input device for transmitting to the output device indicated by the identifier stored in the output device manager in a case of receiving the secret information from the input device.

2. The server device according to claim 1, wherein
the output device is a display apparatus,
the input device is a mouse, and
the connection controller generates operation information of the mouse as the secret information.

3. The server device according to claim 2, wherein the operation information includes operation of a button equipped with the mouse and moving-operation of the mouse.

4. The server device according to claim 3, wherein the connection controller selects the button operation and the mouse moving-operation among a plurality of button operations and a plurality of mouse moving-operations.

5. The server device according to claim 1, wherein
the output device is a display apparatus,
the input device is an optical mouse, and
the connection controller generates image information which can be read by the optical mouse, as the secret information.

6. The server device according to claim 5, wherein
the connection controller generates image information which changes with time, as the secret information.

7. The server device according to claim 1, wherein
the output device is a display apparatus,
the input device is a keyboard, and
the connection controller generates a character string which can be input by the keyboard, as the secret information.

8. The server device according to claim 1, wherein
the output device is a speaker,
the input device is a microphone, and
the connection controller generates voice information which can be input from the microphone, as the secret information.

9. The server device according to claim 1, wherein
the output device is a display apparatus,
the input device is a camera, and
the connection controller generates image information which can be taken by the camera, as the secret information.

10. The server device according to claim 1, wherein
there are a plurality of output devices, and
the connection controller generates different secret information pieces respectively for the output devices.

11. The server device according to claim 1, wherein
the output device manager stores a first user identifier so as to associate with the identifier of the output device,
the communication unit receives an second user identifier, and
the connection controller acquires the output capability information of the output device in a case that the first user identifier coincides with the second user identifier.

12. A server device which generates a result of computation processing based on input information from an input device, comprising:
a communication unit configured to receive a connection request from an output device;
an input device manager configured to store an identifier of the input device; and
an connection controller
configured to acquire input capability information of the input device, the input capability information indicating which kind of input the input device can do,
configured to acquire output capability information of the output device, the output capability information indicating which kind of output the output device can do,
configured to generate secret information which can be input to the input device and can be output by the output device, on the basis of the input capability information and the output capability information,
configured to transmit the secret information to the output device, and
configured to output a result of computation processing based on input information received from the input device indicated by the identifier stored in the input device manager for transmitting to the output device in a case of receiving the secret information from the input device.

13. The server device according to claim 12, wherein
the input device is a mouse,
the output device is a display apparatus, and
the connection controller generates operation information of the mouse as the secret information.

14. The server device according to claim 12, wherein
the input device is an optical mouse
the output device is a display apparatus, and
the connection controller generates image information which can be read by the optical mouse, as the secret information.

15. The server device according to claim 14, wherein
the connection controller generates image information which changes with time, as the secret information.

16. The server device according to claim 12, wherein
the input device is a keyboard
the output device is a display apparatus, and
the connection controller generates a character string which can be input by the keyboard, as the secret information.

17. The server device according to claim 12, wherein
the input device is a microphone
the output device is a speaker, and
the connection controller generates voice information which can be input from the microphone, as the secret information.

18. The server device according to claim 12, wherein
the input device is a camera
the output device is a display apparatus, and
the connection controller generates image information which can be taken by the camera, as the secret information.

19. The server device according to claim 12, wherein
the input device manager stores a first user identifier so as to associate with the identifier of the input device,
the communication unit receives an second user identifier, and
the connection controller acquires the input capability information of the input device in a case that the first user identifier coincides with the second user identifier.

20. A program executed in a server device which receives input information from an input device via a network, and outputs a result of computation processing based on the input information to an output device on the network, comprising:
a program module for receiving a connection request from the input device;
a program module for acquiring output capability information of the output device, the output capability information indicating which kind of output the output device can do;
a program module for acquiring input capability information of the input device, the input capability information indicating which kind of input the input device can do;
a program module for generating secret information which can be input to the input device and output by the output device, on the basis of the output capability information and the input capability information;
a program module for transmitting the secret information to the output device; and
a program module for generating a result of computation processing based on input information received from the input device for transmitting to the output device in a case of receiving the secret information from the input device.
